(19) United States
(12) Patent Application Publication
(10) Pub. No.: US 2016/0238178 A1
(43) Pub. Date: Aug. 18, 2016

(54) Apparatus For Repairing A Pipe

(71) Applicants: Jeffrey M. URBANSKI, Grand Blanc, MI (US); SOURCE 1 ENVIRONMENTAL, LLC, Davison, MI (US)

(72) Inventor: Jeffrey M. Urbanski, Grand Blanc, MI (US)

(21) Appl. No.: 15/031,725

(22) PCT Filed: Oct. 29, 2014
(86) PCT No.: PCT/US14/62944

§ 371 Date: Apr. 23, 2016

Related U.S. Application Data
(60) Provisional application No. 61/896,837, filed on Oct. 29, 2013.

(51) Int. Cl. F16L 55/163

(52) U.S. Cl. CPC F16L 55/163

(57) ABSTRACT

An apparatus and method for repairing a pipe utilizing a pipe lining assembly. The pipe lining assembly may have an inflatable bladder with a first surface opposite a second surface defining a sealed chamber for receiving air. The pipe lining assembly may also have a patch with a first edge and a second edge and is positioned on at least a portion of the first and second surfaces of the inflatable bladder such that the first edge of the patch overlaps said second edge of said patch. The inflatable bladder with the patch positioned thereon is configured such that the first surface of the inflatable bladder overlaps the second surface of the inflatable bladder forming a cylindrical shape.

### CROSS-REFERENCE TO RELATED APPLICATIONS

This PCT Patent Application claims the benefit of U.S. Provisional Patent Application Ser. No. 61/896,837 filed Oct. 29, 2013, entitled “Apparatus And Method For Repairing A Pipe,” the entire disclosure of the application being considered part of the disclosure of this application and hereby incorporated by reference.

### FIELD OF DISCLOSURE

The present invention relates generally to an apparatus and method for repairing a pipe utilizing an inflatable bladder.

### BACKGROUND OF THE DISCLOSURE

Municipalities, cities, and townships have numerous underground pipe lines or conduits designed to carry liquid such as water or sewage throughout the area for commercial, industrial, and residential use. At times, these pipe lines or conduits may experience corrosion or perforation causing cracks to form within the pipe due to the age of the pipe, the material of pipe, and the type of liquid flowing throughout the pipe. Any cracks or damage to the pipe may cause leaks and may result in flooding, spillage of sewer around the pipe line, or decreases in water pressure effecting commercial and industrial entities inside the municipalities, cities, or townships as well as the residential areas utilizing water for non-recreational uses and recreational activities. In the past, municipalities, cities, or townships were forced to shut down or turn off the pipe to fix the crack costing a great deal of time and money. However, recent advances in this area of technology have allowed the municipalities, cities, and townships the ability to fix the corrosion or perforation without having to shut down the pipe line utilizing inflatable bladders along with other equipment including a fiberglass patch.

Typically, the bladders are cylindrical and are made of a rubber material. The bladders are also very heavy and bulky to accommodate the repair of very large pipes. However, these bladders are overly burdensome on the individuals charged with both preparing the bladder for repairing the pipe utilizing a kit and in actual practice of lowering the bladder into the pipe due to the bladders substantial size and weight.

As a result, flat bladders were developed to address the issue of the cylindrical bladders. Such flat bladders may be folded into a W-shape, U-shape, V-shape, or O-shape and may be secured with a strap to maintain the folded bladder's shape. Alternatively, the bladder may remain unfolded. The patch may also be wrapped around the folded or unfolded flat bladder and is then inserted to the pipe for repair. However, problems still exist with the various folded or unfolded flat bladders. First, the bladder may be too difficult to insert into the pipe depending on the shape of the bladder and the size of the pipe. Second, the patch may slide on the bladder because it is merely wrapped around the bladder. In other words, the patch is not secured when the bladder is inserted into and drug through the pipe.

Thus, there is a need for an improved folded inflatable bladder assembly which may be large but can fit in and repair small pipes, that is lightweight, not burdensome to assemble, and which can secure the patch to prevent the patch from sliding around or off the bladder during use.

### SUMMARY OF THE INVENTION

A pipe lining assembly, a pipe lining kit, and a method of repairing a pipe using a pipe lining assembly are provided.

The pipe lining assembly includes an inflatable bladder with a first surface opposite a second surface defining a sealed chamber for receiving air. The pipe lining assembly may also include a patch with a first edge and a second edge is positioned on at least a portion of the first and second surfaces of the inflatable bladder such that the first edge of the patch overlaps the second edge of the patch. The inflatable bladder with the patch positioned thereon is configured such that the first surface of the inflatable bladder overlaps the second surface of the inflatable bladder forming a cylindrical shape.

The pipe lining kit includes an inflatable bladder with a first surface opposite a second surface defining a sealed chamber for receiving air. The pipe lining kit may also include a patch with a first edge and a second edge and is positioned on at least a portion of the first and second surfaces of the inflatable bladder such that the first edge of the patch overlaps the second edge of the patch. The inflatable bladder with the patch positioned thereon is configured such that the first surface of the inflatable bladder overlaps the second surface of the inflatable bladder forming a cylindrical shape. Additionally, the pipe lining kit may include at least one of an air regulator, hose, cable, or air regulator.

The aspect disclosed herein also provides a method for repairing a pipe utilizing a pipe lining assembly. The method includes positioning an inflatable bladder on a patch. The inflatable bladder having a first surface opposite a second surface defining a sealed chamber for receiving air and the patch having a first edge and a second edge and folding the patch on at least a portion of the first and second surfaces of the inflatable bladder such that the first edge of the patch overlaps the second edge of the patch. The method may also include folding the inflatable bladder such that the first surface of the inflatable bladder overlaps the second surface of the inflatable bladder forming a cylindrical shape.

The aspects disclosed herein provide various advantages. First, the inflatable bladder discussed above is less burdensome on individuals preparing and using the bladder for repairs since the bladder is lightweight. Second, the inflatable bladder is more cost efficient since the inflatable bladder employs less material than conventional bladders. Third, the inflatable bladder may be used for repairs without forcing a municipality, city, or township to shut down or turn off the pipe. Fourth, the inflatable bladder is easy to store after finishing repairs since the inflatable bladder is configured to be foldable, the bladder may be folded to fit in small areas. Fifth, the bladder may be large but may repair small pipes. Additionally, the way the bladder and patch are folded together secures the patch to the bladder and prevent the patch from sliding during use.

### BRIEF DESCRIPTION OF THE DRAWINGS

Other advantages of the present invention will be readily appreciated, as the same becomes better understood by reference to the following detailed description when considered in connection with the accompanying drawings wherein:

FIGS. 1A and 1B are illustrations of a perspective view and a side view of an inflatable bladder respectively for use with a patch in repairing a pipe in accordance with the present disclosure;

FIGS. 2A and 2B are illustrations of a top view of a patch in an unfolded and folded configuration respectively for use with an inflatable bladder for repairing a pipe in accordance with the present disclosure;

FIG. 2C is an illustration of a perspective view of a patch and an inflatable bladder for repairing a pipe in accordance with the present disclosure;

FIGS. 3A and 3B are illustrations of a perspective view of an inflatable bladder and a patch within a pipe to be repaired in accordance with the present disclosure; and

FIG. 4 is a flowchart depicting a method of repairing a pipe utilizing an inflatable bladder kit in accordance with the present disclosure.

### DETAILED DESCRIPTION OF THE ENABLING EMBODIMENTS

Detailed examples of the present invention are disclosed herein; however, it is to be understood that the disclosed examples are merely exemplary and may be embodied in various and alternative forms. It is not intended that these examples illustrate and describe all possible forms of the invention. Rather, the words used in the specification are words of description rather than limitation, and it is understood that various changes may be made without departing from the spirit and scope of the invention.

As those of ordinary skill in the art will understand various features of the present disclosure as illustrated and described with reference to any of the Figures may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

The aspects disclosed herein show an inflatable bladder for repairing a pipe configured to fold into a cylindrical or tube-like shape for insertion into a damaged pipe. The aspects disclosed herein also include an inflatable bladder kit and a method for repairing a pipe utilizing an inflatable bladder.

FIG. 3A is an illustration of a perspective view of a pipe lining assembly shown generally at 60 including an inflatable bladder 10 and a patch 50 for use in connection with repairing a pipe 1, both as more fully described herein.

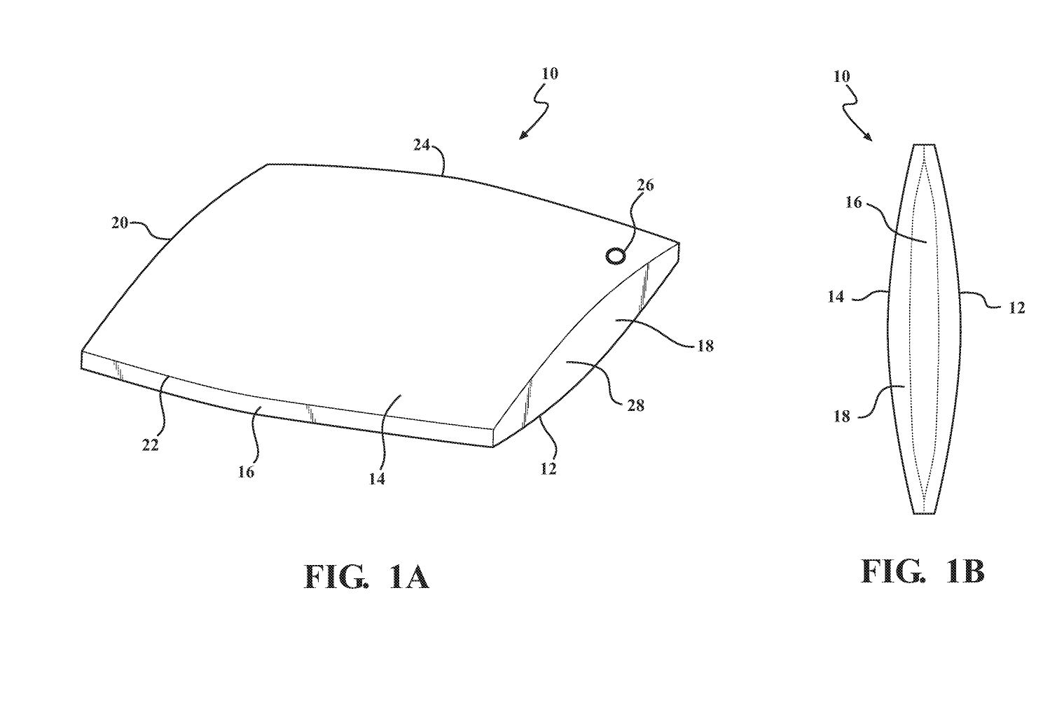

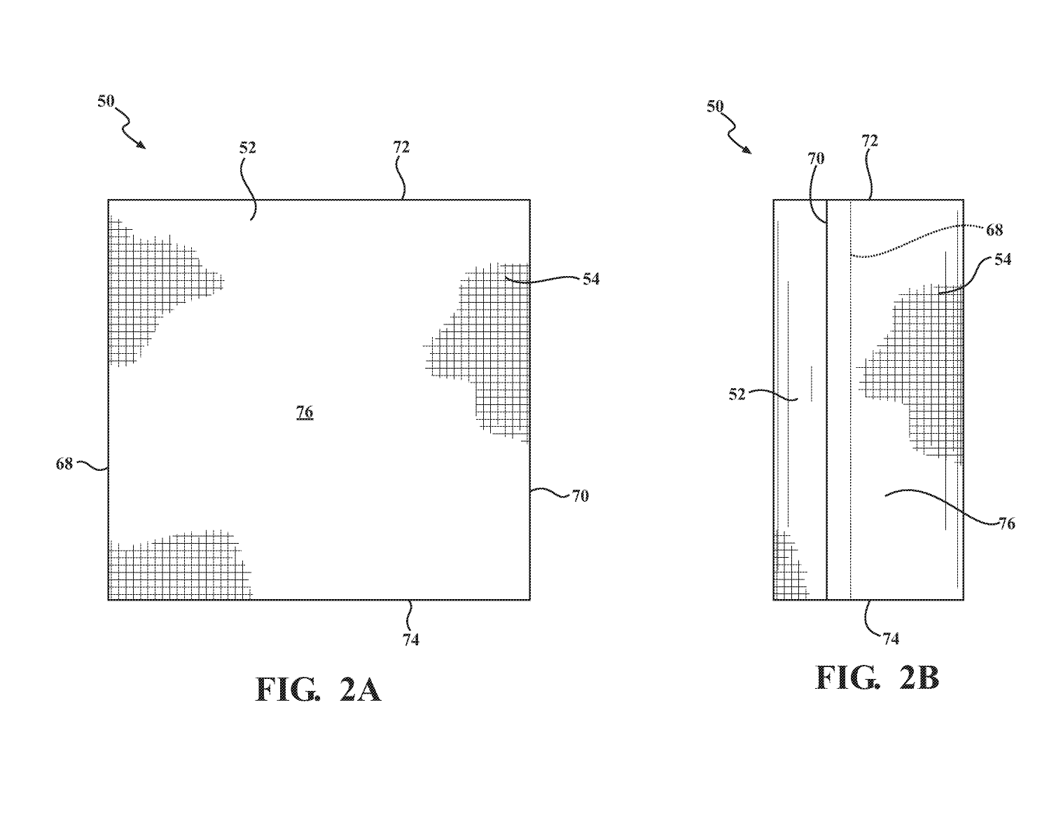

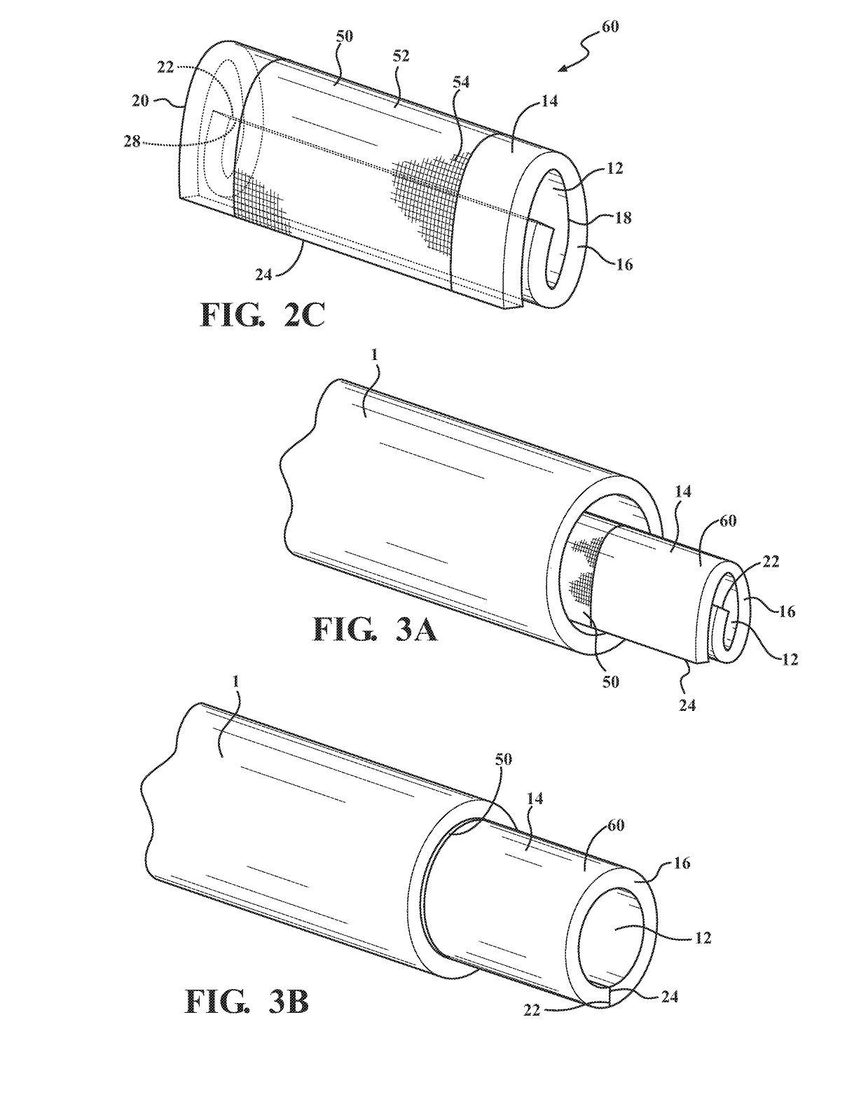

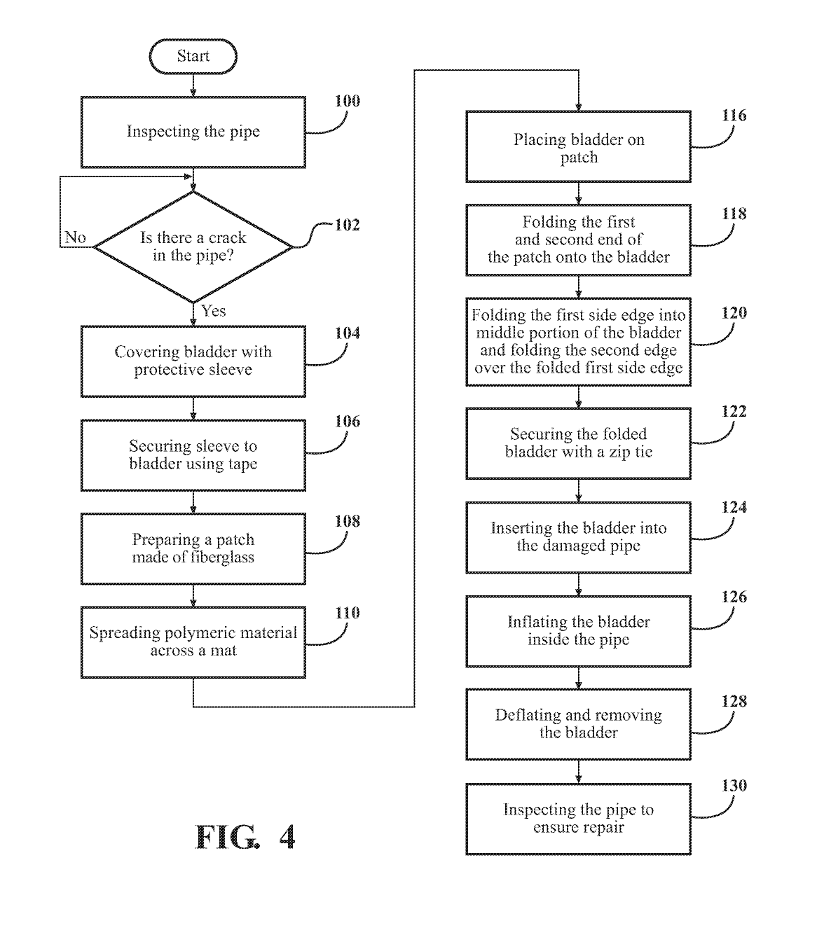

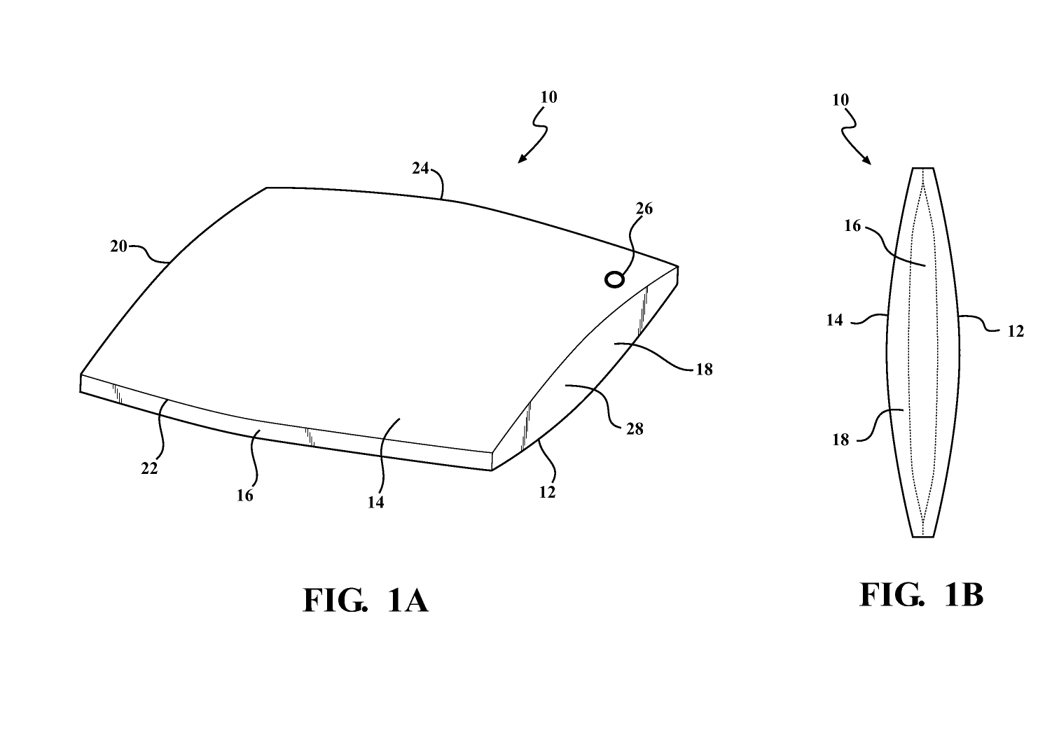

FIGS. 1A and 1B are illustrations of a perspective view and a side view of an inflatable bladder 10 for use with a patch 50 in repairing a pipe 1. The inflatable bladder 10 may be made of a rubber and/or KEVLAR. The inflatable bladder 10 includes a first surface 12, a second surface 14 opposite the first surface 12, the first surface 12 and second surface 14 defining a sealed chamber 16 for receiving air. The sealed chamber 16 includes a first end 18 and a second end 20 generally parallel to each other as well as a first side edge 22 generally parallel to a second side edge 24 and the first side edge 22 and the second side edge 24 are generally perpendicular to the first end 18 and the second end 20. The sealed chamber 16 includes a middle portion 28 extending along the first end 18 and the second end 20 and between the first side edge 22 and the second side edge 24. The middle portion 28 is intended to define a generally central portion of the bladder 10 between the first side edge 22 and the second side edge 24. Additionally, a valve opening 26 is disposed on the bladder 10 for inflating the sealed chamber 16 with air. The valve opening 26 may receive a valve (not shown) and a hose (not shown) to receive air for inflating the sealed chamber 16. Furthermore, the valve opening 26 may be disposed on any portion of the bladder 10.

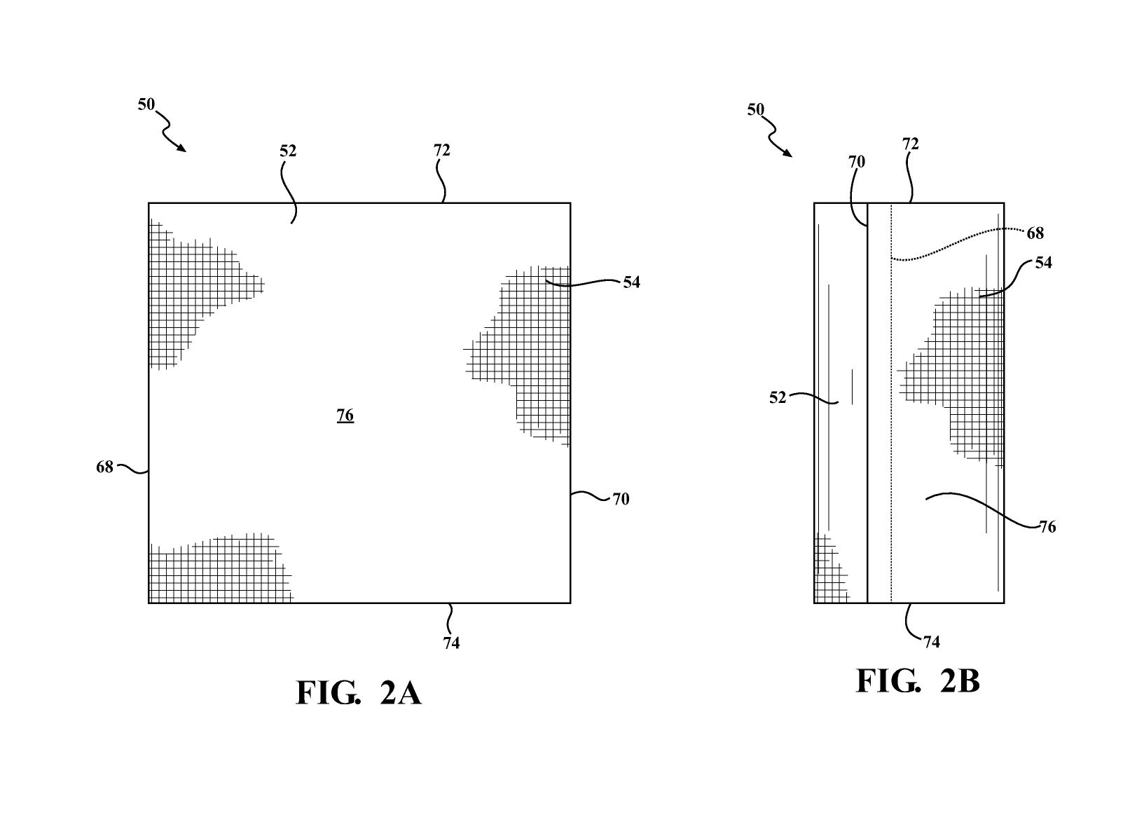

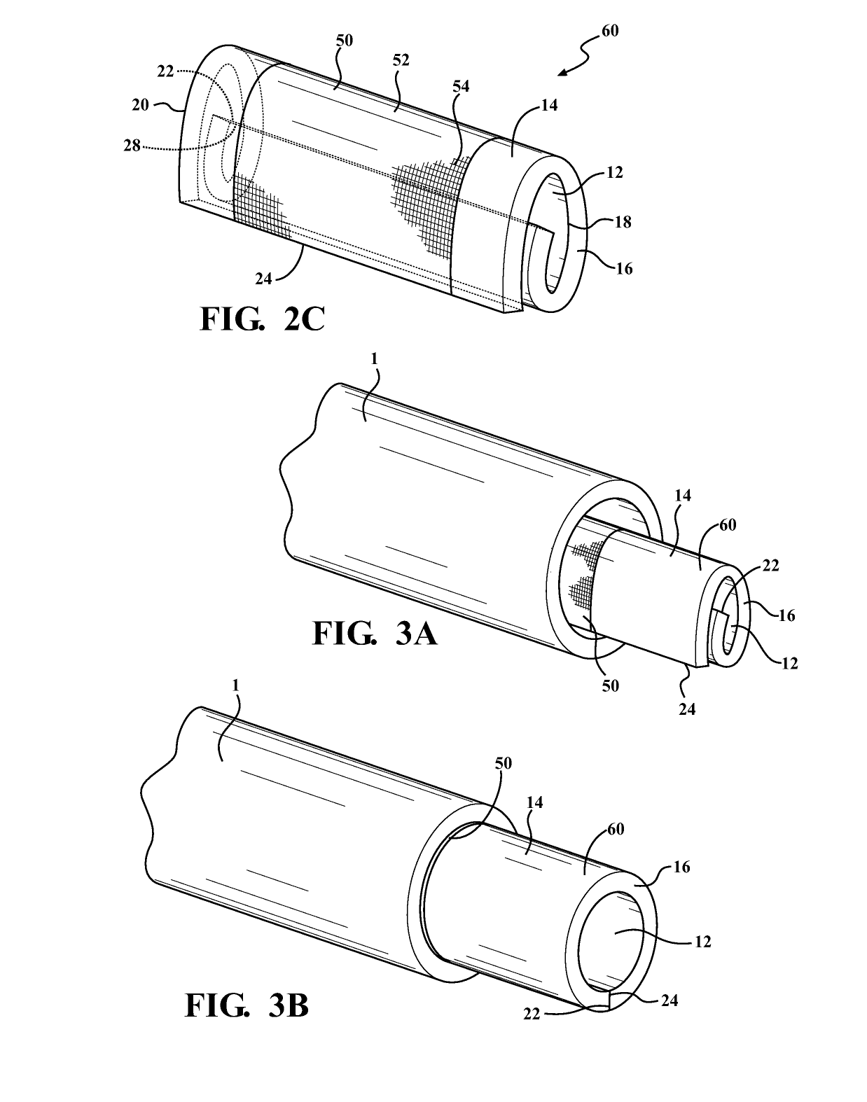

FIGS. 2A and 2B are illustrations of a patch 50 in an unfolded and folded configuration for use with the inflatable bladder 10 for repairing a pipe in accordance with the present disclosure. In particular, FIGS. 2A and 2B show the patch 50 in a flat and folded configuration respectively.

The patch 50 includes a polymeric material 54 and a fibrous mat 52. Specifically, the polymeric material 54 may be mixed or pre-mixed prior to application onto the mat 52. The fibrous mat 52 includes two surfaces. The polymeric material 54 is poured onto one surface of the fibrous mat 52 and spread evenly over such surface. Once the polymeric material 54 is spread evenly onto one surface of the fibrous mat 52, the fibrous mat 52 may be flipped or turned over and the remaining amount or portion of polymeric material 54 is poured onto and spread evenly over the other surface of the fibrous mat 52. In any event, it should be appreciated that both sides of the fibrous mat 52 are coated with the polymeric material 54 to form the patch 50.

The patch 50 may have a generally square or rectangular shape. Additionally, the patch 50 includes a first edge 68 parallel to a second edge 70 and a third edge 72 perpendicular to the first edge 68 and the second edge 70, as well as a fourth edge 74 perpendicular to the first edge 68 and the second edge 70 and parallel to the third edge 72. A middle portion 76 may extend between the first edge 68 and the second edge 70.

The pipe lining assembly 60 includes the inflatable bladder 10 and the patch 50 assembled together (i.e., folded together) for use in connection with repairing a pipe 1, as follows. After having prepared the patch 50 with the fibrous mat 52 and the polymeric material 54 as described above, the inflatable bladder 10 as shown in FIG. 1A, having a protective sleeve (not shown) enclosing the bladder 10, is positioned on one surface of the patch 50. The protective sleeve is provided in order to prevent the polymeric material 54 from improperly adhering to the bladder 10. The patch 50 is assembled together with the bladder 10 by wrapping the patch 50 around both of the first and second surfaces 12, 14 of the bladder 10 such that the second edge 72 of the patch 50 overlaps the first edge 68 of the patch 50 (i.e., folding passed the middle portion 76) as more fully shown in FIG. 2B.

The pipe lining assembly 60 further includes the inflatable bladder 10, along with the protective sleeve, having the patch 50 wrapped thereon, folded into a particular shape for insertion into the pipe 1. As shown in FIG. 2C, the first side edge 22 of the sealed chamber 16 is folded to the middle portion 28 of the sealed chamber 16, and the second side edge 24 of the sealed chamber 16 may be folded across the middle portion 28 of the inflatable bladder 10 and over the first side edge 22 causing the second surface 14 of the inflatable bladder 10 to be directly disposed on such surface 14 in an overlapping manner and forming a cylindrical or tube-like shape.

FIGS. 3A and 3B are illustrations of the pipe lining assembly 60 within a pipe 1. In regards to FIG. 3A, the pipe lining assembly 60 is shown in a folded configuration similar to FIG. 2C. In other words, second side edge 24 overlaps the first side edge 22. It should be appreciated that the inflatable bladder 10 of the pipe lining assembly 60 is shown in FIG. 3A in a deflated condition—in other words, air has not been sent into the chamber 16 through the valve opening 26 to cause the bladder 10 to inflate.

With respect to FIG. 3B, the inflatable bladder 10 of the pipe lining assembly 60 is shown in an inflated condition within the pipe 1. During inflation, the inflatable bladder 10 unfolds as the chamber 16 is filled with air through the valve opening 26 and expands to fill an inner area of the pipe 1. More specifically, as the bladder 10 is filled with air and unfolds, the patch 50 is positioned against an inner diameter of the pipe 1. The patch 50 having the polymeric material 54 adheres to the inner diameter of the pipe 1 thereby causing a broken portion of the inner diameter of the pipe 1 to be sealed and repaired, after removal of the bladder 10 from the pipe 1, as more fully described below.

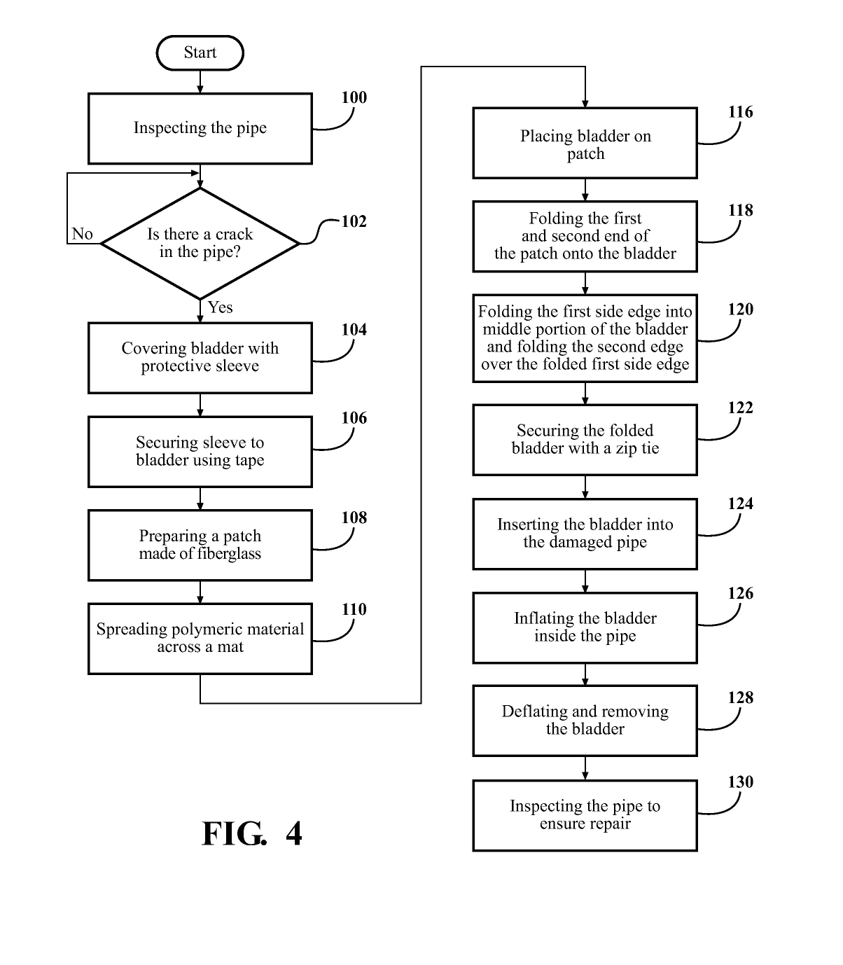

FIG. 4 is a flowchart depicting a method of repairing a pipe utilizing the pipe lining assembly 60. The method includes inspecting the pipe to determine if the pipe 1 is damaged 100 and determining if the pipe 1 is to be repaired shown at 102. For instance, an operator of the inflatable bladder may lower a camera into the pipe to view damage within the pipe 1.

If the pipe 1 can be repair utilizing the pipe lining assembly 60, the pipe lining assembly 60 is covered with a protective sleeve 104. The protective sleeve may be secured to the inflatable bladder 10 using an adhesive material 106. The adhesive material may be vinyl tape or any adhesive material that is water sealed or waterproof. After the protective sleeve is secured to the inflatable bladder 10, the operator may prepare a patch, shown at 108, by spreading polymeric material across both sides of a fibrous mat 110. The fibrous mat may be fiberglass.

After having prepared the patch with the fibrous mat and the polymeric material as described above, the inflatable bladder, having a protective sleeve (not shown) enclosing the bladder, is positioned on one surface of the patch, shown at 116 in FIG. 4. The patch is assembled together with the bladder by wrapping the patch around both of the first and second surfaces of the bladder such that the second edge of the patch overlaps the first edge of the patch (i.e., folding passed the middle portion 76), as shown in FIG. 4 at 118.

The inflatable bladder, along with the protective sleeve and having the patch wrapped in an overlapping manner thereon, is folded into a particular shape. The first side edge of the sealed chamber is folded to the middle portion of the sealed chamber, and the second side edge of the sealed chamber is folded across the middle portion of the inflatable bladder and over the first side edge causing the first surface of the inflatable bladder to be directly disposed on the second surface of the inflatable bladder 10 in an overlapping manner and forming a cylindrical or tube-like shape, as shown at 120 in FIG. 4.

The bladder may be secured in the folded position with at least one fastener to maintain the cylindrical or tube-like shape 122. The at least one fastener may be a zip tie or a plurality of zip ties. For instance, an operator may secure one zip tie at the center of the folded bladder and another zip tie at both ends of the bladder.

The folded bladder may then be inserted into the damaged pipe using at least one pull cable connected to at least one metal link disposed on at least one of the first end and the second end of the bladder 124. Once the folded bladder is inserted into the damaged pipe, the folded bladder may be inflated inside the pipe to a specified pressure based on the size of the pipe 126. The folded bladder may be inflated via a valve disposed on the bladder and may be connected to an air regulator and an air compressor. The inflated bladder expands and allows the fibrous material batch to adhere to the inside of the pipe. The bladder may expand up to three times in size to seal any damage or cracks within the pipe.

After a predetermined amount of time has lapsed, the bladder may be deflated and removed from the pipe leaving the patch behind and the damaged pipe repaired 128. The predetermined amount of time may be around one to three hours. Lastly, the pipe may be inspected using a camera to ensure that the damage is adequately repaired 130.

While examples of the invention have been illustrated and described, it is not intended that these examples illustrate and describe all possible forms of the invention. Rather, the words used in the specification are words of description rather than limitation, and it is understand that various changes may be made without departing from the spirit and scope of the invention. Additionally, the features and various implementing embodiments may be combined to form further examples of the invention.

1. A pipe lining assembly for repairing a pipe, comprising:
an inflatable bladder extending between a first side edge and a second side edge and having a first surface opposite a second surface defining a sealed chamber for receiving air;
a patch having a first edge and a second edge is positioned on at least a portion of said first and second surfaces of said inflatable bladder such that said first edge of said patch overlaps said second edge of said patch; and
wherein said inflatable bladder having said patch positioned thereon is configured such that said first surface of said inflatable bladder overlaps said second surface of said inflatable bladder and said first side edge of said inflatable bladder overlaps said second side edge of said inflatable bladder.

2. The pipe lining assembly of claim 1, wherein said patch includes a fibrous material and a polymeric material.

3. The pipe lining assembly of claim 2, wherein said polymeric material is positioned on at least a portion of both of a first and second side of said fibrous material.

4. The pipe lining assembly of claim 1 wherein said inflatable bladder is positioned on the inside of a protective sleeve.

5. A method for repairing a pipe utilizing a pipe lining assembly, comprising:
positioning an inflatable bladder on a patch, the inflatable bladder extending between a first side edge and a second side edge and having a first surface opposite a second surface defining a sealed chamber for receiving air and the patch having a first edge and a second edge;
folding the patch on at least a portion of the first and second surfaces of the inflatable bladder such that the first edge of the patch overlaps the second edge of the patch; and
folding the inflatable bladder such that the first surface of the inflatable bladder overlaps the second surface of the inflatable bladder and the first side edge of the inflatable bladder overlaps the second side edge of the inflatable bladder.

6. The method of claim 5 further comprising:
inspecting the pipe to determine if the pipe is damage with a camera.

7. The method of claim 5, further comprising:
covering the inflatable bladder with a protective sleeve.

8. The method of claim 5, further comprising:
securing the protective sleeve to the bladder using an adhesive material.

9. The method of claim 5, further comprising:
folding the first side of the patch into a center of the patch; and
folding the second side of the patch into the center of the patch to create an overlap between the first side and second side.

10. The method of claim 5, further comprising:
preparing the patch by spreading polymeric material across both sides of the fibrous mat.

11. The method of claim 5, further comprising:
securing the folded bladder with at least one fastener to maintain the cylindrical shape.

12. The method of claim 11, wherein the at least one fastener is a zip tie.

13. The method of claim 5, further comprising:
inserting the folded inflatable bladder into the damaged pipeline;
inflating the folded inflatable bladder in the damaged pipeline; and
deflating the folded inflatable bladder leaving the cured patch within the pipe after a predetermined amount of time.

14. The method of claim 5, wherein the patch folded within and around the inflatable bladder unfolds and is pressed against the wall of the damaged pipe.

15. The method of claim 5, further comprising:
inspecting the repaired pipe utilizing a camera.

16. The pipe lining assembly of claim 3 wherein said polymeric material is positioned over the entirety of the first and second sides of said fibrous material.

17. The pipe lining assembly of claim 1 wherein said first side edge and said second side edge of said inflatable bladder are disposed in generally parallel relationship with one another.

18. The pipe lining assembly of claim 1 wherein said first edge and said second edge of said patch are disposed in generally parallel relationship with one another.

19. The method of claim 5 wherein the first side edge and the second side edge of the inflatable bladder are disposed in generally parallel relationship with one another.

20. The method of claim 5 wherein the first edge and the second edge of the patch are disposed in generally parallel relationship with one another.
